(19) United States
(12) Patent Application Publication
(10) Pub. No.: US 2014/0327689 A1
(43) Pub. Date: Nov. 6, 2014

(54) Technique for real-time rendering of temporally interpolated two-dimensional contour lines on a graphics processing unit

(71) Applicant: Paul Maravelias, Windham, NH (US)

(72) Inventor: Paul Maravelias, Windham, NH (US)

(21) Appl. No.: 14/332,399

(22) Filed: Jul. 16, 2014

Related U.S. Application Data
(60) Provisional application No. 61/982,336, filed on Apr. 22, 2014.

(51) Int. Cl. G06T 11/00

(52) U.S. Cl. CPC G06T 11/001
USPC 345/582

(57) ABSTRACT

A method for rendering animated contour lines in real-time on a graphics processing unit employs a two-stage rendering technique using two separate pixel shaders and three texture stages. A dynamically generated one-dimensional color key lookup texture is generated and passed to the first pixel shader along with two texture datasets which are blended according to a temporal interpolation fraction for the creation of visual stripes over the dataset which alternate color at predetermined contour values. The result of this first pass is rendered into a screen-defined texture and sent to a secondary pixel shader which performs a simplistic edge-detection algorithm to extract width-normalized contour lines from the edges formed by the striping shader in the first render pass. The edge-detection shader receives user-controllable variables to alter contour thickness, color, border color, and smoothness (anti-aliasing) before presenting the finished image to the graphics display device.

### CROSS-REFERENCE TO RELATED APPLICATIONS

This application claims the benefit of Provisional Patent Application Ser. No. 61/982,336, filed on Apr. 22, 2014, entitled “Technique for real-time rendering of temporally interpolated two-dimensional contour lines on a graphics processing unit,” and incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

1. Field of the Invention

The present invention is directed to the field of computer graphics and, in particular, the necessity of drawing two-dimensional contour line illustrations for a multitude of dataset types and visualization contexts.

2. Description of the Related Art

Graphical display of contour lines, also generally referred to in various contexts as isolines, isopleths, or more rarely, isorithms, is a common task for software applications pertaining to topographical visualization in the form of elevation datasets, meteorological visualization in the form of barometric pressure (isobar), wind (isotach), or temperature (isotherm) datasets, physical geographic visualization in the form of magnetic declination (isogon), to the visualization of socioeconomic/urban planning parameters (isochrone maps), and to many other fields.

Slight methodical variances of contour line generation technique permeate the current state of the art, though the key traditional feature of geometrically extracting vector contour lines from a two-dimensional scalar dataset remains a homogeneous commonality to all existing methods known to the inventor. Multiple algorithms exist to the purpose of facilitating the aforesaid geometric derivation of vector lines from a raster, scalar dataset with computational efficiency, such as presented by Snyder (Snyder, William V. “Algorithm 531: contour plotting [J6].” ACM Transactions on Mathematical Software (TOMS) 4.3 (1978): 290-294.) or by Aramini (Aramini, Michael Joseph. Implementation of an improved contour plotting algorithm. Diss. University of Illinois at Urbana-Champaign, 1981.) Irrespective to the comparative efficiency which any of these traditional methods possesses over another, they are all nonetheless constrained by algorithmic reality to fall short of real-time performance in applications requiring the live display of temporally interpolated datasets, animated datasets, or datasets of otherwise rapidly changing values. Additionally, they leave the visualization of computed contour lines vertices as an additional necessary task for the software to complete, often with the requirement of precise visual control over line thickness and style.

### BRIEF SUMMARY OF THE INVENTION

In an embodiment of the present invention, a two-pass rendering technique produces rasterized contour line graphics employing a per-pixel computation method implemented in a pixel shader program of the programmable rendering pipeline of a graphics processing unit (GPU) using the DirectX 9 API to interface with video hardware.

The aforesaid embodiment of the present invention entirely circumvents the traditional necessity of geometric contour line extraction and subsequent rendering using the geometry pipeline of a graphics processing unit, or any other means of existing vector-based line rendering, by limiting the signal bandwidth to the size of the graphics output display. Therefore, the alteration of contour levels, the alteration of the dataset values, and/or the expansion of the dataset resolution may be achieved in milliseconds without any appreciable impact on performance, if any, which suits the present invention to real-time applications, whereas the aforementioned traditional methods would depend on pre-rendering techniques to achieve the same effect. These traditional techniques are tied to such computational and/or memory usage expenses as to warrant their realistic impracticality in applications to which they would otherwise be well-suited.

An embodiment of the present invention, by means of a width-normalizing edge-detection pixel shader, accomplishes the rendering of contour lines of certain customizable and visually characteristic embellishments, including but not limited to anti-aliasing, colorized line borders, and/or variable thickness, as would suite it to the practical display requirements of many graphics applications requiring aesthetic robustness as well as scientific accuracy. Furthermore, the implementation of such visual features in current states of the art consume, in general, far more graphics processing resources than does the present invention, given their usage of geometric vector data in lieu of the present invention's bandwidth-limited raster (texture) data approach.

### BRIEF DESCRIPTION OF THE SEVERAL VIEWS OF THE DRAWING

For a further understanding of the nature and objects of the present invention, reference should be had to the following detailed description, taken in conjunction with the accompanying drawings, in which like parts are given like reference numerals, and wherein:

FIG. 1 is a flowchart depicting a general, high-level overview of the present invention's rendering method.

FIG. 2 depicts the base texture (0 to 1 normalized grayscale mapping) of a given dataset for contouring.

FIG. 3 demonstrates the same dataset texture after the application of the stripe-keying texture lookup shader of render pass #1.

FIG. 4 depicts the output of the first rendering pass having been secondarily rendered through a simplified embodiment of the present invention's edge detection pixel shader (render pass #2).

### DETAILED DESCRIPTION OF THE INVENTION

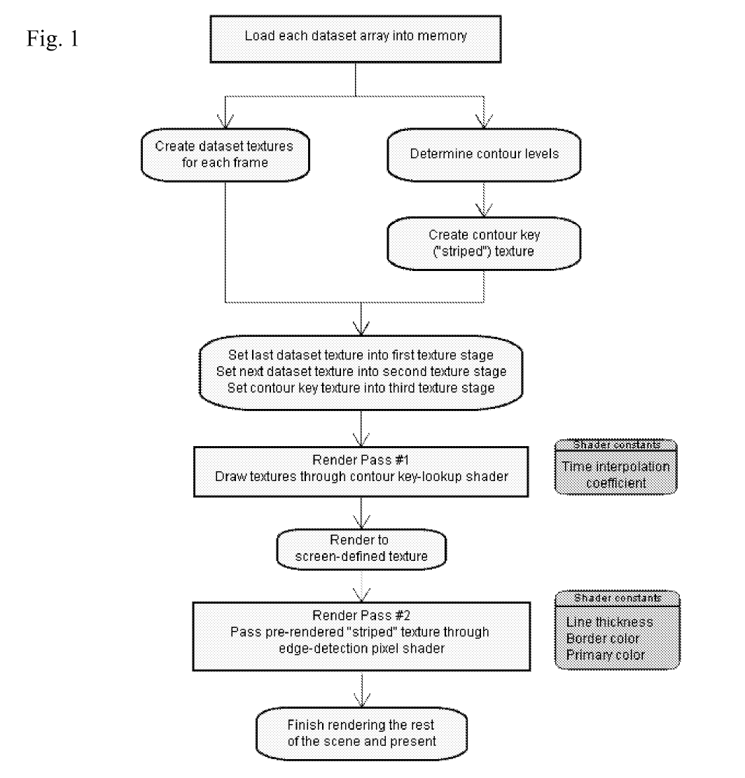

The present invention assumes the preexistence of a display environment in which basic access to graphics hardware through DirectX 9 has been established and also assumes the preexistence of the datasets to which the present contouring algorithm will be applied having been loaded into respective two-dimensional floating point system memory arrays with each array representing the respective, discrete time intervals by which the present time-interpolation feature functions, which is indicated by the first flowchart step in FIG. 1.

Each data array is firstly converted into a respective, corresponding texture to be processed by the graphics processing unit. If the target graphics device supports texture data formats beyond the common 32-bit RGBA format, an embodiment of the present invention will scan for and use a single-channel (often designated as “grayscale”) 16-bit texture format, since only one channel of texel data is used. Luminance texture formats (in particular, “D3DFMT_L16”) are particularly well suited, given their relatively universal support on consumer graphics hardware. The selection of an 8-bit or 32-bit texture data format may accord to the suitability of reduced precision with increased memory efficiency or increased precision with reduced memory efficiency respectively, when the situation warrants. To the purpose of optimizing precision under the range of values afforded by the determined texture format, an embodiment of the present invention discerns the extrema of each dataset and populates each texture field with values relative to those extrema by remapping them to texel-space values normalized to the range 0.0f to 1.0f (i.e., the minimum and maximum possible texel values depending on the aforementioned texture format). The present invention populates each texture therefore according to a simple linear interpolation,

$$T ( x , y ) = {T ( x , y )}_{max} \times ( \frac{D ( x , y ) - {D}_{min}}{{D}_{max} - {D}_{min}} )$$

where T(x, y) represents the current texel, T(x, y)ₘₐₓ represents the maximum texel value, D(x, y) represents the current data point in the given data frame, and where Dₘₐₓ and Dₘᵢₙ represent the pre-computed extrema values of the given data frame.

In the event of such relative rescaling of each successive data frame as it pertains to the values stored in each texture, constant values which remap the extrema of each frame to the potentially greater extrema of the entire dataset are passed along to the first pixel shader, which is otherwise described in a following section, in order to rescale the data accordingly such that they are properly relative to the entire dataset. This step may be left out if the above rescaling process is itself eschewed, opting for an embodiment of the present invention which stores absolute data values into each texel when the data are thus within bounds and additional interpolative precision is not necessary. An additional embodiment of the present invention renders contour lines for one single static data frame, in which the step described in this paragraph is unnecessary.

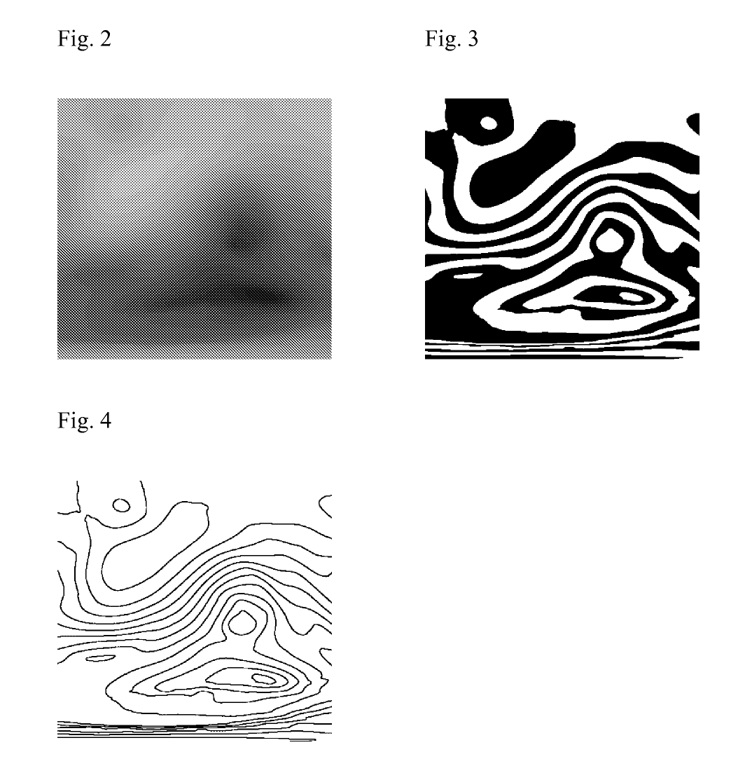

FIG. 2 depicts the basic appearance of such a dataset texture stored as simple grayscale values and mapped to the known relative extrema of the dataset.

In accordance to the second task proceeding from the top of the attached flowchart in FIG. 1, the present invention next determines the contour values to be displayed and creates a corresponding “key” or “striping” one-dimensional lookup texture to be used in the first rendering pass. The specifics of this rendering technique and a description of its purpose are given in the following section; in the immediately following, it is only necessary to specify the manner of said contour key texture's construction.

The present invention constructs the contour key texture with a 1×1024 height/width dimension, with X=0 spatially representing the minimum of all the data frame mimima, and X=1023 spatially representing the maximum of all the data frame maxima (i.e., the width of the texture represents a linear progression across the range of the entire dataset including all two-dimensional subfields for which each texture data frame is created). The texture is then filled with either white or black texels, alternating at such boundaries which define the desired contour levels. For example, if the given dataset contains three frames, the maxima of which being 200 units, 300 units, and 250 units respectively, and the minima of which being −100 units, −500 units, and −350 units respectively, and the chosen contour interval being 50 units, 16 stripes (i.e., alternations between black and white) will be present in the corresponding contour key texture (since the range of the extrema, 300−(−500)=800, divided by the contour interval of 50=16), with switches in color occurring at every 64 pixels in the 1024 pixel-wide texture (since 1024/16=64). The user may elect to create custom and/or non-regular contour intervals which may be implemented by reconstructing this contour key texture with the same linear interpolation which maps texture coordinates (0 to 1023 texels, or normalized texture coordinates 0.0f to 1.0f) to the minimum and maximum representative values of the dataset respectively. The distinct advantage of present invention's ability to rapidly alter contour intervals without excessive re-computation is thus noted, since only the re-creation of this small texture (requiring only milliseconds on modern hardware) is necessary for the updating of contour intervals.

In preparation for the first rendering pass, three textures must be sent through the graphics pipeline. An embodiment of present invention which renders temporally interpolated contour lines of a multi-frame dataset is described, and therefore a floating-point variable T is specified to represent the decimal position of such an animation's temporal progression through the dataset wherein the whole part of the decimal represents the number of the last data frame and wherein the decimal part represents the interstitial, incomplete temporal progression to the next frame. For example, if a given dataset to be temporally interpolated contains fifty frames, and the speed of such an animation is designated such that the graphics display will allot 250 milliseconds to each frame, T would equal exactly 4.5 at 1125 ms into the animation, since a whole total of four frames have elapsed (250 ms×4 frames) and the graphics display device is rendering a frame equidistant (by 125 ms) to both the last frame (frame #4) and to the next frame (frame #5). The fractional component of this floating-point, frame-referenced time value T is taken and passed to the render pass #1 pixel shader. The first texture stage is set to the dataset texture whose temporal frame number is the whole part of the decimal T (i.e., the last frame to which the current animation has fully progressed) and the second texture stage is set to that of the former frame plus one, being the proceeding dataset texture, to which the first is temporally interpolated based on the floating-point variable T which indicates the animation's linear, continuous progression between the temporally discrete frames.

In a simpler embodiment of the present invention, no time interpolation is performed and contour lines are drawn for a single given dataset, in which the current procedure is easily altered to eschew the processing of a secondary frame texture and treating the given frame as final for usage in the subsequent steps of the rendering process.

The third texture stage (or second, in the event of the simpler embodiment aforementioned) is set to the pre-generated contour key texture. The desired display geometry is rendered (a simple “quad” consisting of two right triangles for flat two-dimensional displays) with these texture settings and with the activation of the first pixel shader employed in this first rendering stage. Alternate embodiments of the present invention may apply time-interpolated contour lines to non-flat surfaces (such as a three-dimensional globe) with no procedural alterations other than rendering these textures with the specifically desired geometry, since contour lines are generated by a pixel-based rather than geometric-based method.

The first pixel shader, used in the hereunto described rendering pass #1, is required to perform, firstly, the temporal interpolation of the two datasets and, secondly, the assignment of the contour keying texture.

In the first requirement of the present invention's pixel shader for rendering pass #1, both textures are sampled with the corresponding HLSL tex2d( ) function and linearly interpolated based on the time-interpolation coefficient. The shader now possesses a final floating-point value which represents in texture-normalized coordinates the linearly interpolated data value at the precise time in between each frame. In the embodiment of the present invention, aforementioned in paragraph [0025], which does not perform time-interpolation, said floating point value may be directly sampled from the single texture without any linear interpolation to another frame.

The second requirement of the present invention's pixel shader for rendering pass #1 maps the aforesaid floating point data-representative value onto the one-dimensional contour keying texture to obtain a final color output value from this shader. The HLSL tex1d( ) function is invoked to sample the contour keying texture at the certain X position (or, in texture coordinates, the certain U coordinate) which corresponds to the present floating point data value. The contour key texture is constructed, as described in paragraph [0023], so that each of its lateral extrema (0.0f and 1.0f respectively) proportionally correspond to the texture-interpolated value. Therefore the pixel shader in render pass #1 will yield the output of either a solid black or solid white pixel, depending on the relative position of the interpolated data value on the continuum of the contour key texture.

The graphic resulting from the hereunto specified rendering pass #1 is rendered into an off-screen, render-target texture with the dimensions of the screen viewport such that it shall be rendered again through a secondary pixel shader in rendering pass #2 for final presentation to the display device. An embodiment of the present invention will detect non-power-of-two texture dimensions of the current viewport and, if it being the case and if it being necessary to comport with the texture creation requirements of the present graphics hardware, create a texture for the rendering output of render pass #1 which is constructed under the dimensions in each horizontal and vertical component of the next highest device-valid power-of-two. The texture is then re-rendered as a “quad” consisting of two right triangles in screen space (with accordingly attenuated texture coordinates, if the above texture rescaling process is necessary, so that the rendered portion of the texture occupies the entire screen and with unaltered dimensions) under the application of pixel shader #2.

FIG. 3 demonstrates the output of rendering pass #1 given the initial dataset presented in FIG. 2 and an example contour interval chosen for the one-dimensional contour keying texture. This figure demonstrates the inefficacy for drawing contour lines of simply creating a “striping” texture as is done in the above but with more narrow intervals which themselves would be intended to represent the finished contour lines, due to the variable data-space derivatives made visible by the static striping ranges in areas of comparatively constant values to other areas of a higher rate of change. It is the respective boundaries, however, between the two colors which constitute lines of equal value and which are therefore the artifact by which the remainder of the present invention's method extracts proper, width-normalized contour lines.

The second pixel shader, in now rendering pass #2, performs a simple edge detection algorithm to extract the boundaries of the “stripes” created in rendering pass #1 and generate the final contoured image. Various general and adaptable edge-detection algorithms exist and may be incorporated to this purpose. An embodiment of the present invention uses HLSL's tex2d function to sample the relative change in color between right and left U-component comparisons multiplied by corresponding top and bottom V-component comparisons to obtain a final floating-point derivative variable which serves to approximate the immediate rate of change at a given pixel. Incidentally, this value is zero between the contour levels (solid internal areas of each strip) and rapidly increases as distance to the inter-stripe boundaries approaches zero. When this derivative value is above a certain threshold, the pixel shader outputs a user-chosen color for the contour line, and elsewhere is it left transparent. This accomplishes the basic visual output of time-interpolated, width-normalized contour lines.

Furthermore, more elaborate embodiments of the present invention achieve contour line bordering and/or anti-aliasing by adjusting the color output values relative to certain threshold boundaries of the aforementioned pixel-space derivative value. For example, when the derivative is above a certain threshold, the shader outputs the primary contour color, and when it is both below the aforementioned threshold yet above a secondary, lower threshold, the border color is output, and below said threshold, an interpolation on the alpha transparency of the border color from 1.0f to 0.0f is performed down to some critical threshold beyond which the contour line does not exist.

In an embodiment of the present invention, contour line width is controlled not by alteration of the aforementioned pixel-space derivative thresholds, but by an increase in the edge-detector's horizontal and vertical offset comparison distances by which the derivative value is firstly obtained.

The present invention's use of the HLSL tex2d( ) function affords backwards compatibility to older graphics hardware on which the use of the newer ddx( ) and ddy( ) functions are not supported; though on graphics hardware supporting shader model PS_{—}2_X or greater, the aforementioned functions may be used in lieu of the tex2d( ) functions to produce a slightly more accurate result and with less cumbersome pixel shader code.

FIG. 4 portrays the final output of render pass #2 and the present invention's achievement of temporally interpolated two-dimensional contour lines.

1. A method for rasterizing width-normalized contour lines of a given two-dimensional dataset necessarily using a DirectX 9 pixel shader program by means of the following steps:
creating a two-dimensional grayscale texture on the graphics device analogous in width and height to the dataset whose every texel represents the according dataset value relative to the extrema of the dataset and rescaled to 0 to 1 normalized texel values;
rendering said texture to another texture using a pixel shader which colorizes each fragment as either black or white according to the fragment value's being mapped to a pre-computed, one-dimensional, black-white-alternating lookup texture whose alternations between black and white define the relative contour intervals to be produced; and
rendering this new texture in a second pass with an edge-detection pixel shader which extracts contour lines from the edges formed by the black and white areas produced in the last step, and which receives adjustable variables controlling the width and color of said lines.

2. A method identical to that method claimed in claim 1, but which achieves the rendering of contour lines for an animated dataset with multiple two-dimensional frames comprising the following steps:
creating textures as described in claim 1 for all of the temporally successive data frames;
rendering to a viewport-sized texture with the usage of the first pixel shader described in claim 1 but with the adjustment that it first linearly interpolates the two nearest data frames according to the animation's temporal progression before performing the aforesaid black-or-white colorizing texture lookup operation; and
rendering said texture in a second render pass with the same edge-detection pixel shader as described in claim 1.
